(19) United States
(12) Patent Application Publication
(10) Pub. No.: US 2002/0149185 A1
(43) Pub. Date: Oct. 17, 2002

(54) Airbag module

(75) Inventors: Joachim Lutz, Schechingen (DE); Robert Mohr, Weinstadt (DE)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(73) Assignee: TRW Occupant Restraint Systems GmbH & Co. KG

(21) Appl. No.: 10/122,612

(22) Filed: Apr. 12, 2002

(30) Foreign Application Priority Data
Apr. 17, 2001 (DE) 201 06 598.3

(51) Int. Cl. B60R 21/28

(52) U.S. Cl. 280/740

(57) ABSTRACT

An airbag module for a vehicle occupant restraint system comprises a gas generator, an airbag which can be inflated by means of a pressurized gas flow that can be supplied by the gas generator. The airbag module further comprises a housing that has a generator chamber to accommodate the gas generator and an airbag chamber to accommodate the airbag. A deformable dividing wall is provided between the generator chamber and the airbag chamber, the dividing wall having outlet openings and being adapted to be deformed by the pressurized gas flow from a resting state into a working state in which the dividing wall forms a guide channel for the pressurized gas flow flowing out of the gas generator.

### TECHNICAL FIELD

The invention relates to an airbag module for a vehicle occupant restraint system.

### BACKGROUND OF THE INVENTION

Conventional airbag modules comprise a gas generator, an airbag that can be inflated by means of a pressurized gas flow that can be supplied by the gas generator, and a housing that has a generator chamber to accommodate the gas generator and an airbag chamber to accommodate the airbag. The invention also relates to a vehicle structure with such an airbag module. It is desirable to control the expansion of the airbag in such a way that the airbag first expands in a predetermined direction, for example, not towards the vehicle occupant but rather towards the side. The inflation process or the expansion direction of the airbag can be controlled, for example, by guide means for the gas flowing out. U.S. Pat. No. 5,988,677 describes an airbag module that has such a guide means in the form of a cap formed on the generator housing, the cap extending from the gas generator towards the cover between the folds of the folded airbag. This design, however, has the drawback that the cap reduces the space available for accommodating the folded airbag pack. Furthermore, with such a cap, the unfolding direction of the airbag can only be controlled to a limited extent, since the cap cannot project beyond the outer contour of the airbag module.

Therefore, the object of the invention is to provide a space-saving airbag module with which the expansion direction of the airbag can be controlled during the inflation.

### BRIEF SUMMARY OF THE INVENTION

According to the invention, an airbag module for a vehicle occupant restraint system comprises a gas generator, an airbag that can be inflated by means of a pressurized gas flow that can be supplied by the gas generator. The airbag module further comprises a housing that has a generator chamber to accommodate the gas generator and an airbag chamber to accommodate the airbag. A deformable dividing wall is provided between the generator chamber and the airbag chamber, the dividing wall having outlet openings and being adapted to be deformed by the pressurized gas flow from a resting state into a working state in which the dividing wall forms a guide channel for the pressurized gas flow flowing out of the gas generator. In the resting state, the guide means takes up only a minimal amount of space so that the installation space available can be used for accommodating the airbag. When the airbag is being inflated, the dividing wall is deformed by the gas flow in such a way that it forms a guide channel that can also project into the airbag chamber and even beyond the housing of the airbag module. Using the guide channel, the gas flow can be guided in a predetermined direction and thus a purposeful expansion of the airbag can be achieved in a predefined manner.

Additional advantageous embodiments of the invention ensue from the subordinate claims.

### BRIEF DESCRIPTION OF THE DRAWINGS

FIG. 1 shows a cross-section through an airbag module according to a first embodiment of the invention in the non-deployed state;

FIG. 2 shows a cross-section through the airbag module of FIG. 1 in the deployed state;

FIG. 3 shows a cross-section through an airbag module according to a second embodiment of the invention in the non-deployed state;

FIG. 4 shows a cross-section through an airbag module according to a third embodiment of the invention in the deployed state;

FIG. 5 is a perspective view of the housing of the airbag module of FIG. 4 with a diffuser plate in the non-deployed state; and

FIG. 6 is a perspective view of the housing of the airbag module of FIG. 5 with a diffuser plate in the deployed state.

### DETAILED DESCRIPTION OF THE PREFERRED EMBODIMENTS

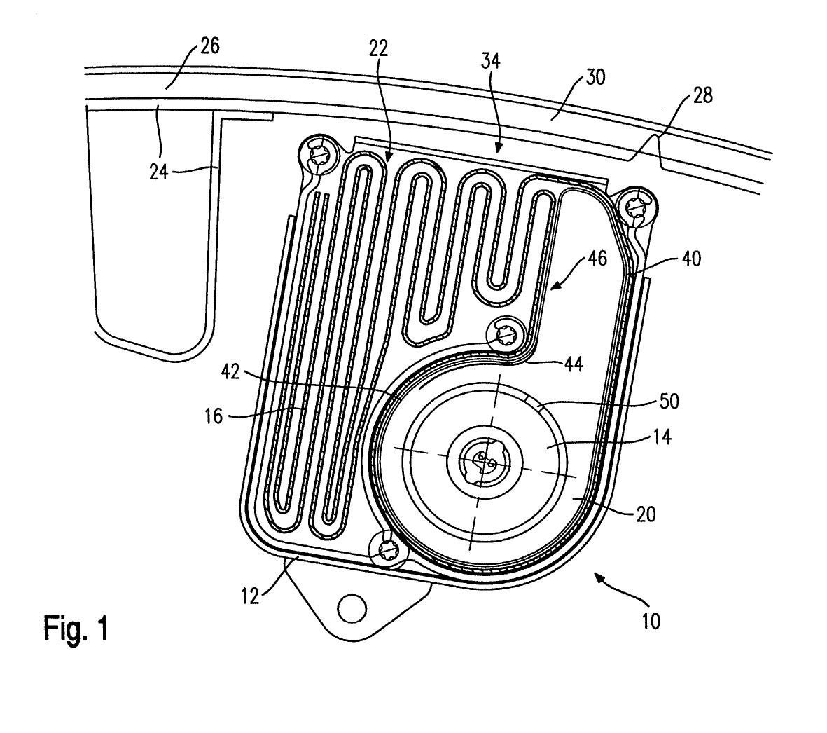

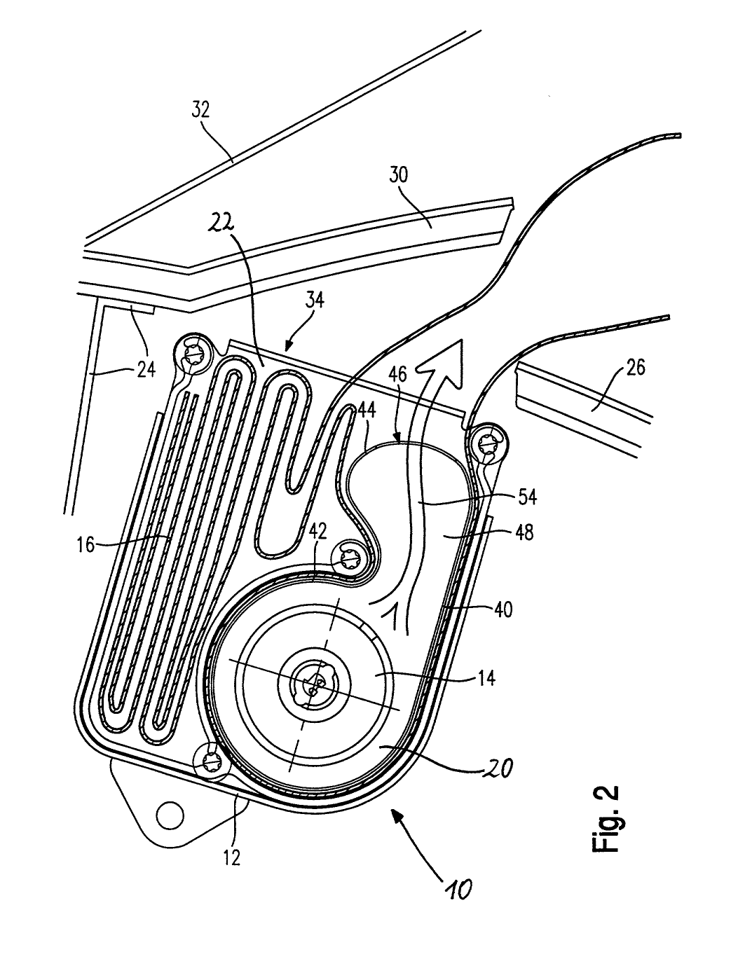

The airbag module 10 in FIGS. 1 and 2 has a housing 12 that contains a tubular gas generator 14 and a folded airbag 16. The airbag module 10 is installed in a dashboard 24 of a vehicle, namely, on the passenger side. The dashboard is provided with a cladding 26 having a predetermined breaking line 28 so that a flap 30 in the cladding 26 can open up towards a windshield 32. The flap 30 forms a cover for an opening 34 in the housing 12 of the airbag module through which the airbag 16 can come out.

The housing 12 advantageously consists of an extruded aluminum section. The inside of the housing 12 is divided into a generator chamber 20 and an airbag chamber 22. In the housing 12, between the generator chamber 20 and the airbag chamber 22, there is provided a dividing wall in the form of a deformable diffuser plate 40. The diffuser plate 40 surrounds the generator 14 so that no additional attachment of the diffuser plate 40 in the module housing 12 is necessary.

In this embodiment, the diffuser plate 40 consists of a metal strip, for example, made of aluminum or sheet metal, with a thickness of less than one millimeter. The diffuser plate has a first end 42 and a second end that forms a tab 44 that is pushed under the first end 42. The tab 44 can already be inserted before the installation of the diffuser plate 40 so that, in the version shown, the diffuser plate 40 is a pre-assembled component. In the area of the second end, the diffuser plate 40 is provided with outlet openings 46 that face into the airbag chamber 22.

Advantageously, the airbag 16 completely surrounds the diffuser plate 40 so that on the one hand, the airbag 16 is attached in the housing 12 and on the other hand, no seal is needed between the gas generator 14 and the airbag 16. The diffuser plate 40, in turn, forms a protective cover for the surrounding fabric layer, for example, against hot combustion residues, that might be ejected by the gas generator.

When the airbag module 10 is activated, the gas generator 14 is ignited. The pressurized gas it generates escapes through an opening 50 in the gas generator and flows into the generator chamber 20 between the gas generator and the diffuser plate 40. As a result of the pressure of the gas flowing out, the tab 44 is pulled out and deformed, so that the diffuser plate 40 forms a guide channel 48 that projects into the airbag chamber 22 and expands towards the outlet opening 34 (FIG. 2).

As an alternative, the diffuser plate 40 can also be closed, that is to say, the first end 42 and the tab 44 are permanently attached to each other, for example, by means of welding, or the plate can be made of a tube. In these cases, the tab 44 cannot be pulled out, but rather the guide channel 48 is formed exclusively by the plastic deformation of the diffuser plate 40 as a result of the pressure exerted by the gas flowing out.

The guide channel 48 directs the pressurized gas flow 54 from the gas generator 14 into the airbag, the flow being oriented directly in the desired unfolding direction of the airbag 16, namely away from the windshield 32. Since there is only one fabric layer of the airbag 16 between the cover and the diffuser plate 40, the airbag 16 is not ejected completely as a folded pack but rather, at first, only a few fabric layers are pushed out of the folded airbag pack. Subsequently, the rest of the folded airbag is drawn out. This has the advantage that no heavy weights are in motion but rather only a few fabric layers.

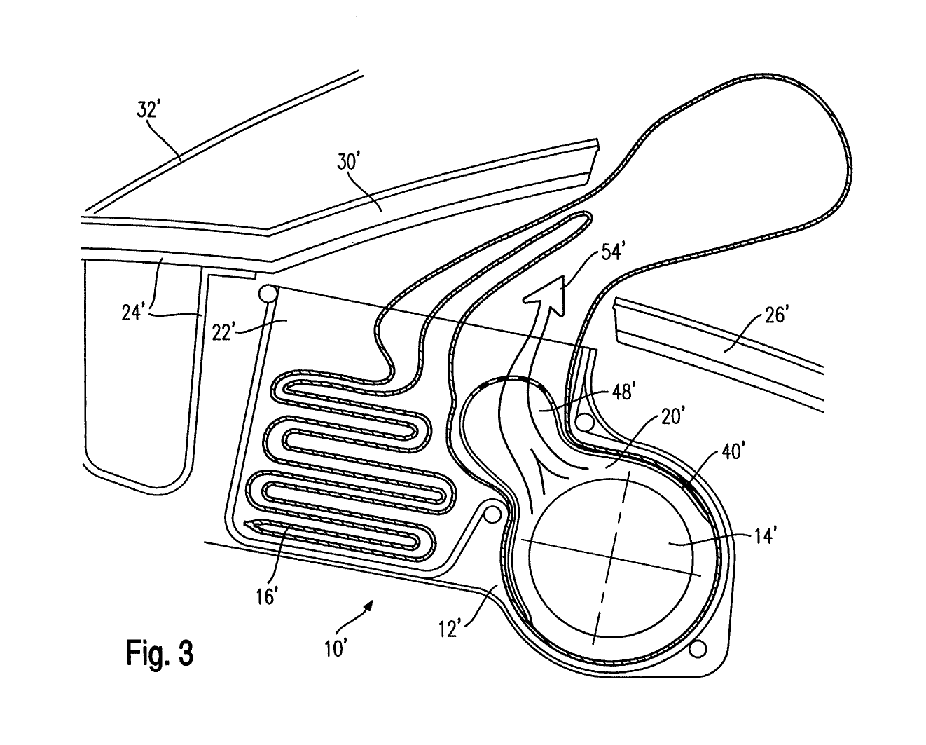

FIG. 3 shows a second embodiment of an airbag module 10′ with which the generator chamber 20′ is situated further to the side in comparison to the first embodiment, as a result of which the module 10′ takes up a wider but less deep installation space in the dashboard 24. Here, it becomes especially clear that the channel 48′ formed by the pulled-out tab 44′ can direct the gas flow 54′ in the desired direction.

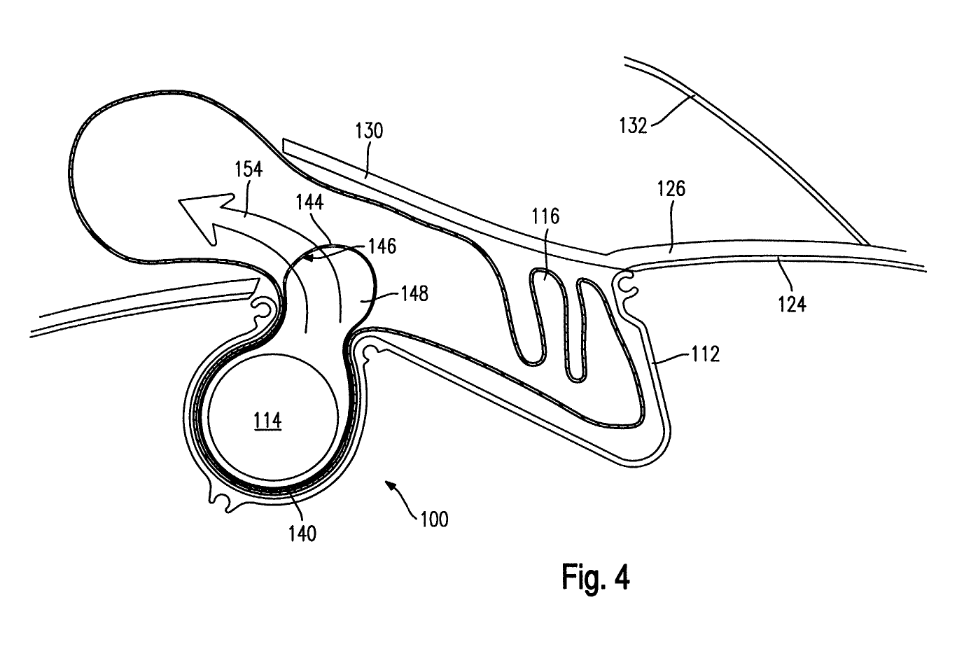

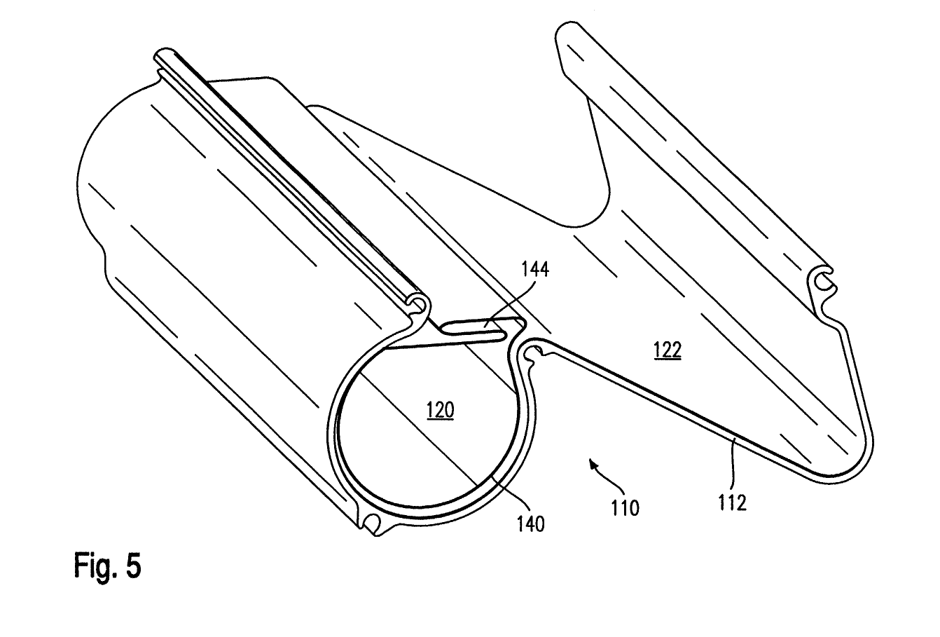

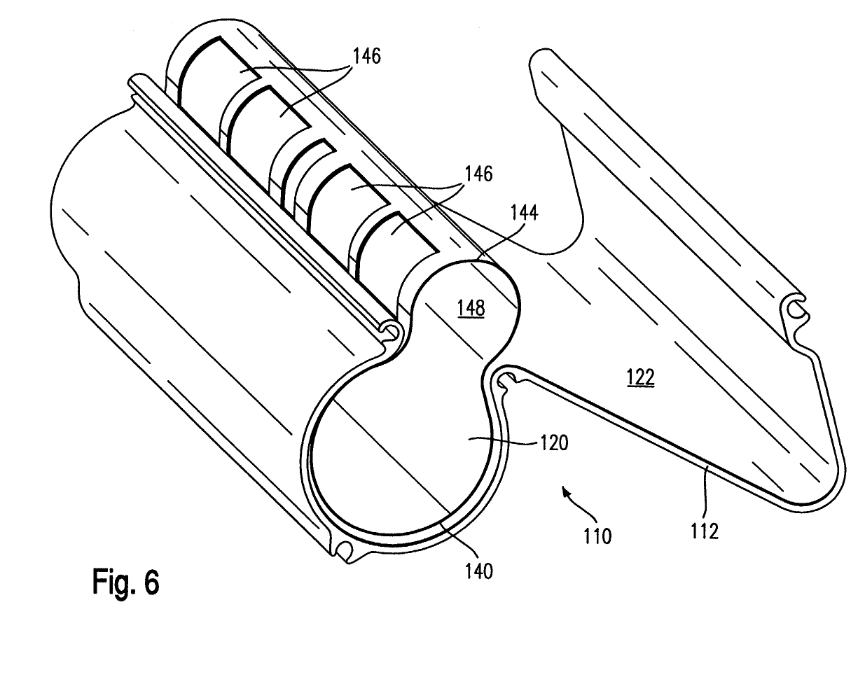

Another embodiment of the airbag module according to the invention is shown in FIGS. 4 and 5, in which reference numerals augmented by 100 are used for already known components. The depiction in FIGS. 5 and 6 is limited to the essential elements, namely, a housing 112 and a diffuser plate 140. The housing 112 once again consists of an extruded section with a generator chamber 120 and an airbag chamber 122. The diffuser plate 140 is placed in the generator chamber 120 and, as in the already described embodiments, it surrounds a gas generator 114. In the transition area 126 between the generator chamber 120 and the airbag chamber 122, the diffuser plate 140 has a folded section 144 that is provided with outlet openings 146.

When the airbag module 110 is activated, the folded section 144 is unfolded by the pressure of the gas flow until it forms a guide channel 148 that projects out of the housing 112 and directs the gas flow 154 in the intended direction, namely, away from the windshield 132, towards the vehicle occupant. Due to the folded section 144, a great deal of space is saved inside the module housing 112. Nevertheless, after the activation of the airbag module, the desired deflection of the gas flow 154 is achieved, which would not be possible without the diffuser plate 140.

1. An airbag module for a vehicle occupant restraint system, said airbag module comprising a gas generator, an airbag which can be inflated by means of a pressurized gas flow that can be supplied by said gas generator, and a housing that has a generator chamber to accommodate said gas generator and an airbag chamber to accommodate said airbag, a deformable dividing wall being provided between said generator chamber and said airbag chamber, said dividing wall having outlet openings and being adapted to be deformed by said pressurized gas flow from a resting state into a working state in which said dividing wall forms a guide channel for said pressurized gas flow flowing out of said gas generator.

2. The airbag module according to claim 1, wherein a deformable diffuser plate is provided that functions as said dividing wall.

3. The airbag module according to claim 1, wherein said dividing wall surrounds said gas generator.

4. The airbag module according to claim 1, wherein a cover is provided that closes said housing towards outside and has an opening line, and wherein said guide channel directs said pressurized gas flow toward said opening line.

5. The airbag module according to claim 4, wherein there is arranged only one fabric layer of said airbag between said dividing wall and said cover.

6. A vehicle structure comprising a windshield, a dashboard and an airbag module comprising a gas generator, an airbag that can be inflated by means of a pressurized gas flow that can be supplied by said gas generator, and a housing that has a generator chamber to accommodate said gas generator and an airbag chamber to accommodate said airbag, a deformable dividing wall being provided between said generator chamber and said airbag chamber, said dividing wall having outlet openings and being adapted to be deformed by said pressurized gas flow from a resting state into a working state in which said dividing wall forms a guide channel for said pressurized gas flow flowing out of said gas generator, said airbag module being installed in said dashboard, and said guide channel directing said gas flow away from said windshield.
